(19) United States
(12) Patent Application Publication
(10) Pub. No.: US 2011/0215514 A1
(43) Pub. Date: Sep. 8, 2011

(54) SHEET FINISHING APPARATUS, MOVING MECHANISM FOR SAME APPARATUS, AND MOVING METHOD FOR SAME APPARATUS

(75) Inventors: Yasunobu Terao, Shizuoka (JP); Tatsuhisa Naraoka, Shizuoka (JP)

(73) Assignees: Kabushiki kaisha Toshiba, Tokyo (JP); Toshiba Tec Kabushiki Kaisha, Tokyo (JP)

(21) Appl. No.: 13/027,193

(22) Filed: Feb. 14, 2011

Related U.S. Application Data
(60) Provisional application No. 61/311,254, filed on Mar. 5, 2010.
(60) Provisional application No. 61/318,254, filed on Mar. 26, 2010.

(51) Int. Cl. B65H 39/10; F16M 11/20

(52) U.S. Cl. 270/58.08; 248/647; 414/800

(57) ABSTRACT

Certain embodiments provide a sheet finishing apparatus including: a machine body; a finishing mechanism; a frame structure; a base; plural first holders pivotally supported on the base and turn around vertical pivots; plural first wheels pivotally supported on the plural first holders and rotate around horizontal axles shifted from the pivots of the first holders; a second holder pivotally supported on the base and is directed downward from a part of the base, the part passing through an apparatus center, and turns around a vertical pivot; a second wheel pivotally supported on the second holder, rotates around a horizontal axle intersecting the pivot of the second holder, and has a greater diameter than a diameter of the first wheel; and an elastic member connected between the second holder and the base and extends and reduces a spacing between the horizontal axle of the second wheel and the base.

### CROSS-REFERENCE TO RELATED APPLICATION

The present application claims the priority benefit of the next U.S. Provisional Applications: U.S. Provisional Application Ser. Nos. 61/311,254, filed on Mar 5, 2010, and 61/318,254, filed on Mar. 26, 2010, the entire contents of which are hereby incorporated by reference.

### FIELD

Embodiments described herein relate generally to a sheet finishing apparatus, a moving mechanism for a sheet finishing apparatus, a moving method for a sheet finishing apparatus.

### BACKGROUND

A sheet finishing apparatus is connected to an MFP (multi-function peripheral) or a copy machine. A sheet discharge port of the MFP and a sheet entrance of the sheet finishing apparatus are connected with each other.

To align the height of the discharge port from a floor surface with the height of the entrance from the floor surface is important.

However, when the floor surface is sloped or stepped, the two heights need to be adjusted. During the adjustment, a person moves the sheet finishing apparatus toward the MFP and moves the sheet finishing apparatus away from the MFP.

A machine body of the MFP is introduced, for example, in front of a wall. The sheet finishing apparatus is required to be easily carryable. A space may be small in relation to reciprocating strokes of the sheet finishing apparatus on the floor surface.

The sheet finishing apparatus must be prevented from moving after being fixed, while easiness of carrying the sheet finishing apparatus is secured.

### DESCRIPTION OF THE DRAWINGS

FIG. 1 shows the configuration of a sheet finishing apparatus according to a first embodiment;

FIG. 2 is a perspective view of a moving mechanism of the sheet finishing apparatus according to the first embodiment;

FIG. 3A is a side view of a castor including a first holder and a first wheel used for the sheet finishing apparatus according to the first embodiment;

FIG. 3B is a side view of a castor including a second holder and a second wheel used for the sheet finishing apparatus according to the first embodiment;

FIG. 4A is a perspective view of a spring-loaded castor including the second holder, the second wheel and an elastic member used for the sheet finishing apparatus according to the first embodiment;

FIG. 4B is a partial perspective view of the spring-loaded castor shown in FIG. 4A;

FIG. 5 shows the configuration of a sheet finishing apparatus according to a second embodiment;

FIG. 6 is a perspective view of the sheet finishing apparatus according to the second embodiment;

FIG. 7A is a side view of a spring-loaded castor including a rotation regulating member used for the sheet finishing apparatus according to the second embodiment;

FIG. 7B is a bottom view of the spring-loaded castor shown in FIG. 7A;

FIG. 7C is a front view of the spring-loaded castor shown in FIG. 7A;

FIG. 8A is a back view of the spring-loaded castor including the rotation regulating member, the second holder and the second wheel used for the sheet finishing apparatus according to the second embodiment; and

FIG. 8B shows the state where the rotation regulating member regulates the rotation of the second wheel, used for the sheet finishing apparatus according to the second embodiment.

### DETAILED DESCRIPTION

Certain embodiments provide a sheet finishing apparatus comprising: a machine body including a supply port for a sheet from an image forming apparatus and a discharge port for a sheet bundle including one or more of the sheet; a finishing mechanism configured to perform finishing of the sheet supplied from the supply port and generate the sheet bundle; a frame structure configured to support the finishing mechanism and the machine body; a base provided on the frame structure; plural first holders respectively pivotally supported on the base and each of the plural first holders is directed downward from the base and pivotally turns around a vertical pivot; plural first wheels respectively pivotally supported on the plural first holders and each of the plural first wheels rotates around a horizontal axle shifted from the pivot of each first holder; a second holder pivotally supported on the base and is directed downward from a part of the base, the part passing through an apparatus center of the sheet finishing apparatus, and pivotally turns around a vertical pivot; a second wheel pivotally supported on the second holder, rotates around a horizontal axle intersecting the pivot of the second holder, and has a greater diameter than a diameter of the first wheel; and an elastic member connected between the second holder and the base, and extends and reduces a spacing between the horizontal axle of the second wheel and the base.

Hereinafter, a sheet finishing apparatus, a moving mechanism for the sheet finishing apparatus and a moving method for the sheet finishing apparatus will be described in detail with reference to the accompanying drawings as examples. In the drawings, the same parts are denoted by the same reference numerals and duplicate explanation is omitted.

### FIRST EMBODIMENT

A sheet finishing apparatus according to a first embodiment is a finisher. A moving mechanism of the sheet finishing apparatus according to the first embodiment is a trolley unit at the bottom of the finisher.

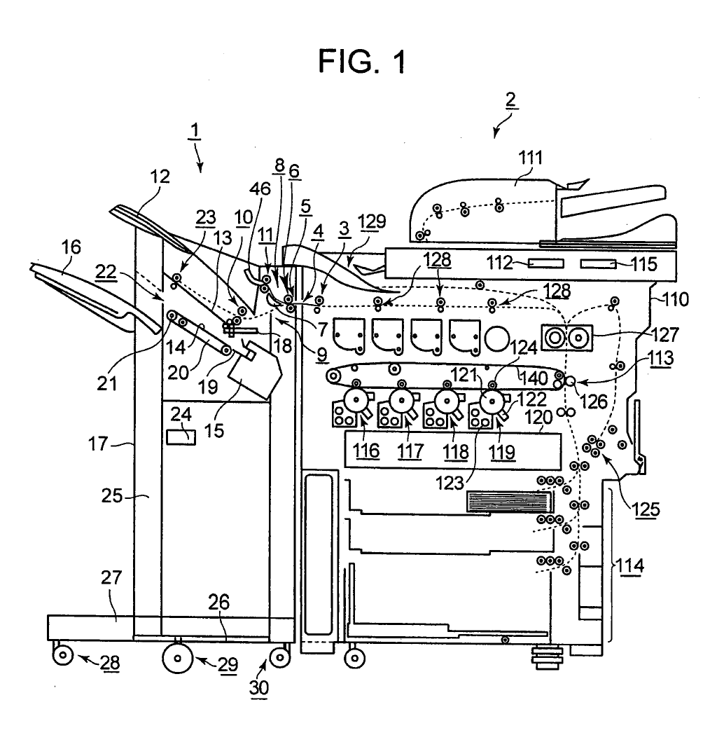

FIG. 1 shows an exemplary internal configuration of the finisher and an MFP. A finisher 1 executes finishing of sheets. The finishing of sheets refers to stacking plural pages of sheets, sorting and stapling the sheets.

An MFP 2 prints and outputs a sheet. The MFP 2 has a pair of discharge rollers 3. The discharge rollers 3 discharge the printed sheet from a discharge port 4. The discharge port 4 is connected with a supply port 5 of the finisher 1.

The finisher 1 has a pair of entrance rollers 6 near the supply port 5, and a branching member 7 which switches a path of the sheet. The entrance rollers 6 receive the sheet and then carry and output the sheet. The branching member 7 guides the sheet from the entrance rollers 6 to either an upper space 8 or a lower space 9.

The space 8 defines a sheet path for discharging the sheet without finishing. The space 9 defines a sheet path for discharging the sheet with finishing.

When the finisher 1 executes finishing, the branching member 7 closes an entrance of the space 8. The branching member 7 guides the sheet to a pair of paper supply rollers 10 via the space 9.

When the finisher 1 does not execute finishing, the branching member 7 closes an entrance of the space 9. The branching member 7 guides the sheet to a pair of final rollers 11.

The final rollers 11 discharge the sheet onto a fixed tray 12.

The finisher 1 has a lever 46 for jam processing on the exit side of the final rollers 11. The lever 46 is for canceling a nip between the pair of final rollers 11.

The finisher 1 has a standby tray 13 downstream from the paper supply rollers 10 in a carrying direction. The finisher 1 has a processing tray 14, a stapler 15 (finishing mechanism), and a paper discharge tray 16.

The standby tray 13 has a pair of tray plates on the standby tray 13. The tray plates move to the left and right of a sheet moving direction. The left and right means a direction of the depth of a machine body 17. Driven by a belt or the like, the standby tray 13 moves guide members away from each other and thus causes the sheet to fall by its own weight.

The finisher 1 has the processing tray 14 below the standby tray 13. The processing tray 14 guides the sheet falling from the standby tray 13, to the stapler 15.

The stapler 15 is a finishing mechanism which staples a sheet bundle. During stapling, the processing tray 14 clamps a rear end of the sheet bundle and thus aligns the sheet bundle.

The finisher 1 has a paddle 18 at the bottom of a slope of the standby tray 13. The paddle 18 aligns an uppermost sheet of the sheet bundle in the sheet moving direction.

The finisher 1 has a stopper 19 at an end of the processing tray 14 on the side of the stapler 15. The stopper 19 regulates a position of a rear end of the sheet.

The processing tray 14 has a carrying belt 20 and a discharge roller 21. The carrying belt 20 carries the sorted or stapled sheets to the paper discharge tray 16. The discharge roller 21 discharges the sheets via a discharge port 22 to the paper discharge tray 16.

The finisher 1 has another pair of rollers 23 above the discharge port 22. The finisher 1 may discharge the sheets on the standby tray 13 to the paper discharge tray 16 via the discharge port 22 without stapling the sheets.

The finisher 1 has a controller 24 which controls the entire finisher 1. The controller 24 receives a control signal from the MFP 2.

The finisher 1 has plural poles 25, a base plate 26 connected to each pole 25, and two beams 27 (only one of which is shown) fixed to the base plate 26.

The poles 25, the base plate 26 and the beams 27 form a frame structure which supports the stapler 15.

The finisher 1 has five pivotal castors. Three of the pivotal castors are spring-loaded castors. A spring refers to a coil spring.

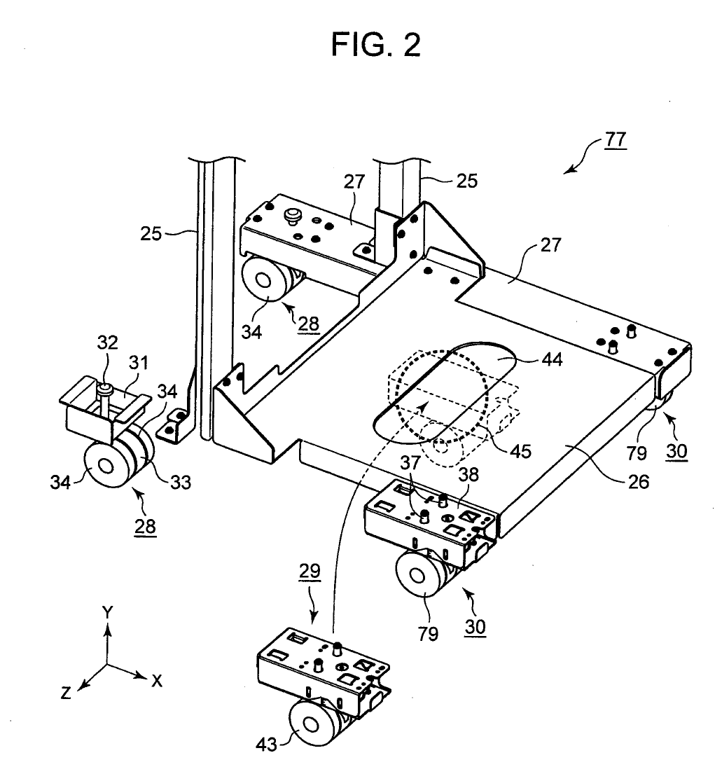

FIG. 2 shows a positional relation of the five castors including the spring-loaded castors, and shows a moving mechanism according to this embodiment. The reference numerals that are already mentioned refer to the same elements. A symbol x refers to the right side facing the front, of the machine body 17. A symbol y refers to the height from a floor surface. A symbol z refers to the front side of the machine body 17.

The finisher 1 has two castors 28, an opening 44 at a central part of the base plate 26, one spring-loaded castor 29 attached below the opening 44, and two other spring-loaded castors 30.

One of the castors 28 has a case-like bracket 31, a shaft 32 penetrating the bracket 31, a holder 33 (a first holder) fixed to the shaft 32, and double wheels 34 (first wheels) each of which is held on the holder 33 as a bearing.

The wheels 34 pivotally turn around a perpendicular line on the floor surface. The wheels 34 rotate on the floor surface. The castor 28 moves forward or backward.

The bracket 31 is fastened to the pole 25 by an L-plate or the like. The poles 25, the base plate 26 and the beams 27 are fastened to each other using rivets, L-plates, bolts and nuts or the like.

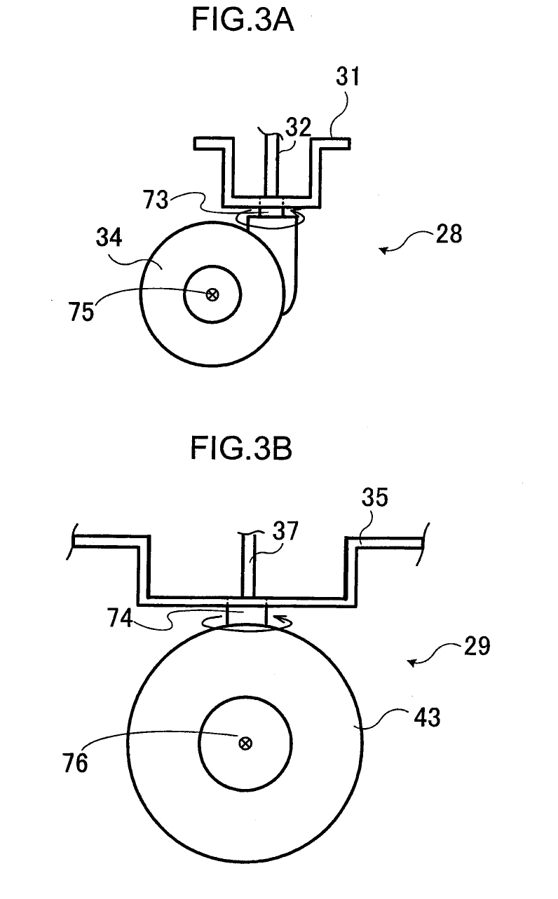

FIG. 3A is a side view of the castor 28. The reference numbers that are already mentioned refer to the same elements. The castor pivotally turns around a pivotal center axis 73. The pivotal center axis 73 and a horizontal axle 75 of the wheels 34 are shifted from each other. The pivotal center axis 73 passes ends of the wheels 34.

The other castor 28 is similar to the one castor 28. The two castors 28 are connected to the base plate 26, with the horizontal axles of the castors arranged parallel to each other.

The spring-loaded caster 29 has, for example, four springs each of which extends and contracts in up and down directions.

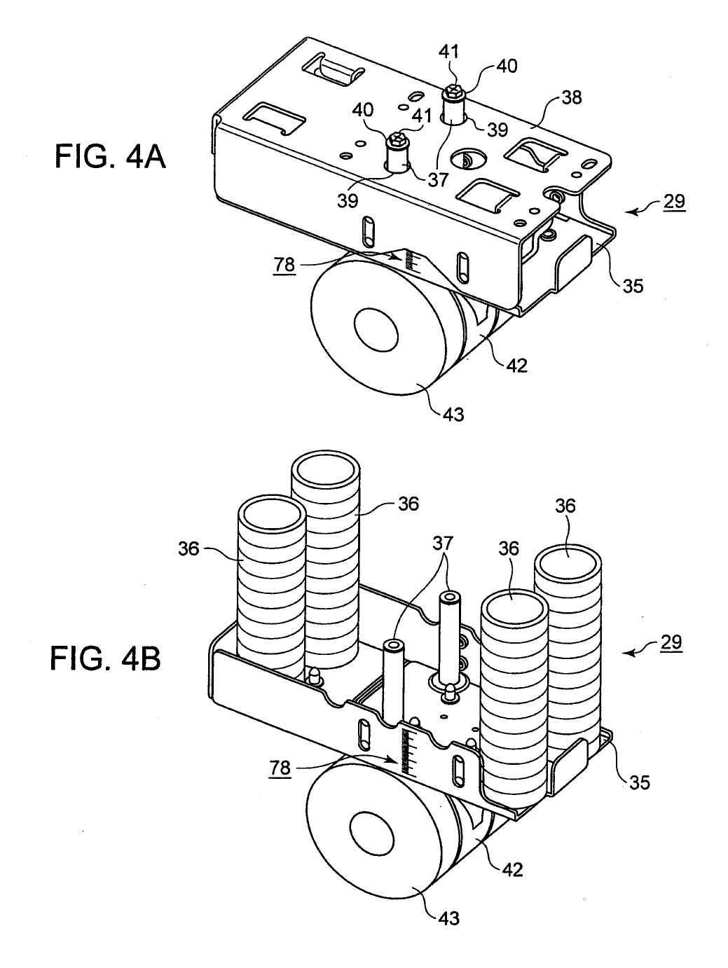

FIG. 4A is a perspective view of the spring-loaded castor 29. FIG. 4A shows the state where load is applied to the springs. FIG. 4B is a partial perspective view of the spring-loaded castor 29. FIG. 4B shows the state where no load is applied to the springs.

The spring-loaded castor 29 has a case-like lower bracket 35, four springs 36 each of which stands upright on the bottom of the lower bracket 35, and two bosses 37 on the bottom, as shown in FIG. 4B. At least one spring 36 is an elastic member.

The spring-loaded castor 29 has an upper bracket 38 covering the lower bracket 35, two openings 39 in the upper bracket 38, and two screws 41 that are driven into the two bosses 37 protruding upward through the openings 39, as shown in FIG. 4A.

The four springs 36, while being contracted, apply an upward force to a top wall of the upper bracket 38 from below.

The spring-loaded castor 29 has washers 40 between the bosses 37 and the screws 41. The washers 40 hold a top surface of the upper bracket 38.

A diameter of the washers 40 is greater than a diameter of the openings 39. The bosses 37, the washers 40 and the screws 41 regulate the upward movement of the upper bracket 38. The spring-loaded castor 29 is thus made flexible in up and down directions.

The spring-loaded castor 29 also has a holder 42 (a second holder) fixed to the lower bracket 35, and double wheels 43 (second wheels) held on the holder 42 as a bearing.

The wheels 43 pivotally turn around a perpendicular line on the floor surface. The wheels 43 rotate on the floor surface. The spring-loaded castor 29 moves forward or backward.

As shown in FIG. 2, the spring-loaded castor 29 is attached to the back side of the base plate 26 and directed downward from the base plate 26. The opening 44 lets distal ends of the bosses 37 out upward.

A position where the spring-loaded castor 29 is attached is within an area 45.

The area 45 is an area passing through the apparatus center of the finisher 1.

The area 45 refers to, for example, a cylindrical space area in a bottom part of the finisher 1.

As viewed from above the base plate 26, the area 45 refers to a circular area including a point at which a perpendicular line passing through the apparatus center of the finisher 1 intersects the base plate 26, or a vicinity of this circular area.

Discharged sheets are stacked and the weight of the finisher 1 changes. Positions of movable members such as the paper discharge tray 16 and the stapler 15 change. A center of gravity of the finisher 1 may enter the area 45.

A bolt and a nut or a screw is used to fix the spring-loaded castor 29 to the base plate 26. As a fixing method, for example, a through hole is provided in a case member or plate member and a bolt and a nut are screwed together through the through hole, thus fixing the top side of the upper case 35 with the bottom side of the base plate 26.

The diameter of the wheels 43 of the spring-loaded castor 29 is greater than the diameter of the wheels 34 of the two castors 28.

FIG. 3B is a side view of the spring-loaded castor 29. The reference numerals that are already mentioned refer to the same elements. The spring-loaded castor 29 pivotally turns around a pivotal center axis 74. The pivotal center axis 74 and a horizontal axle 76 of the wheels 43 intersect each other.

The structure of the spring-loaded castors 30 on the side closer to the MFP 2 is substantially the same as the structure of the spring-loaded castor 29. The two spring-loaded castors 30 are connected to the base plate 26, with the horizontal axles of the castors 30 arranged parallel to each other.

Wheels 79 of the two spring-loaded castors 30 shown in FIG. 2 pivotally turn around a perpendicular line on the floor surface. The wheels 79 rotate on the floor surface. The spring-loaded castors 30 move forward or backward.

In the spring-loaded castors 30, too, the pivot and the horizontal axel are shifted from each other, as in the example of FIG. 3A.

The base plate 26, the two beams 27, the two castors 28, the spring-loaded castor 29 and the two spring-loaded castors 30 constitute a trolley unit 77. The trolley unit 77 is a moving mechanism of the finisher 1.

The above is mainly the description of the finisher 1. Hereinafter, the MFP 2 will be described.

As shown in FIG. 1, the MFP 2 has a machine body 110, a scanner unit 111, an image processing unit 112, a printer unit 113, a paper supply unit 114, and an MFP control unit 115.

The machine body 110 is connected to the finisher 1. The scanner unit 111 scans a surface of an original. The scanner unit 111 converts a read image information to an analog signal. The image processing unit 112 converts tricolor image data from the scanner unit 111 to four print colors.

The printer unit 113 forms an image on a sheet and outputs the sheet. The printer unit 113 has image forming units 116, 117, 118 and 119 for four colors, and a laser exposure device 120. The image forming units 116, 117, 118 and 119 are arrayed along an intermediate transfer belt 140.

For example, the image forming unit 116 for black is provided with a photoconductive drum 121, a charger 122, a developing device 123, and a transfer device 124. The configuration of the image forming units 117, 118 and 119 is substantially the same as the configuration of the image forming unit 116.

The paper supply unit 114 supplies a sheet to the printer unit 113. The MFP control unit 115 generates a print job. The MFP control unit 115 causes the controller 24 of the finisher 1 to execute finishing designated by the print job.

The MFP 2 has plural pairs of rollers 125 for pulling a sheet from the paper supply unit 114, a secondary transfer roller pair 126, and a fixing device 127.

The MFP 2 has several pairs of rollers 128 downstream from the fixing device 127 in the sheet carrying direction. The fixing device 127 and the plural pairs of rollers 128 define a carrying path.

The MFP 2 has a discharge port 129, the discharge roller 3 and the discharge port 4 in the carrying path. The discharge port 129 opened in an upper part of the machine body 110. The discharge port 4 faces the supply port 5 of the finisher 1.

The finisher 1 of the above configuration receives a horizontal manual force, then the castors 28, the spring-loaded castor 29 and the spring-loaded castors 30 rotate. The finisher 1 moves forward and backward and pivotally turns on the floor surface.

In the state where the spring-loaded castor 29 supports the apparatus center of the finisher 1, a horizontal force is applied to the finisher 1. Then the finisher 1 smoothly moves on the floor surface.

A moment of inertia about a z-axis within the area 45 is smaller than a moment of inertia outside of the area 45. The spring-loaded castor 29 exists in the area 45 where the moment of inertia is relatively small. The spring-loaded castor 29 directly supports the apparatus center or the center of gravity which concentrates in the area 45. The finisher 1 can be smoothly moved.

A method of aligning a position of the supply port 5 of the finisher 1 and a position of the discharge port 4 of the MFP 2 will now be described.

A person roughly aligns the height of the finisher 1 and the height of the MFP 2.

The spring-loaded castor 29 sinks because of the weight of the finisher 1. As the springs 36 of the spring-loaded castor 29 flex, the height of the supply port 5 from the floor surface and the height of the discharge port 4 from the floor surface are adjusted.

As shown in FIG. 4A and FIG. 4B, a scale 78 may be notched in advance on a lateral side of the lower bracket 35. The scale 78 enables visual recognition of the length the machine body 17 sinks. The scale 78 makes the finisher 1 easier to align the height of the finisher 1 with the height of the MFP 2.

When the two positions and heights are not aligned, a person pulls the finisher 1 in the state where the spring-loaded castor 29 supports the finisher 1.

The finisher 1 smoothly moves away from the MFP 2. The finisher 1 moves backward. The person applies a pivotal turning force to the finisher 1 in the state where the spring-loaded castor 29 supports the finisher 1.

When necessary, forces for moving forward, moving backward and pivotal turn may be repeatedly applied to the finisher 1. The alignment is thus completed. The heights are also adjusted by the load applied to the springs 36.

The spring-loaded castor 29 makes the finisher 1 easier to adjust the height of the finisher 1 in the up and down directions. The diameter of the wheels 43 of the spring-loaded castor 29 is greater than the diameter of the wheels of the two castors 28. The weight of the finisher 1 securely acts on the spring-loaded castor 29.

The finisher 1 can realize both two functions, that is, easiness of carrying and easiness of adjusting the height position.

The arrangement of the spring-loaded castor 29 alone at the center will be described.

Directions of the two castors 28 and the two spring-loaded castors 30 change in accordance with a direction in which the finisher 1 moves. The castors 28 and the spring-loaded castors 30 follow the direction in which the finisher 1 moves.

The finisher 1 is heavy. When a traveling direction of the wheels 34 and a traveling direction of the wheels 79 are the same, the castors 28 and the spring-loaded castors 30 move forward smoothly.

When the finisher 1 is stopped, an attempt is made to move the finisher 1 backward in a direction opposite to a direction of forward movement. A following direction of the wheels 34 of the castors 28 and a following direction of the wheels 79 of the spring-loaded castors 30 are opposite to a direction of backward movement of the finisher 1.

A certain force is needed to change the following direction of the castors 28 and the following direction of the spring-loaded castors 30. Otherwise the finisher 1 does not move smoothly.

In fact, even when the following directions of the wheels 34 and 79 are opposite to the direction of backward movement of the finisher 1, the spring-loaded castor 29 can follow the movement of the finisher 1.

The finisher 1 can easily be introduced beside the MFP 2 even when the floor surface is sloped or stepped. For example, even when the room is small, the finisher 1 can be moved easily.

The finisher 1 can maintain its position after the finisher 1 is fixed, while easiness of carrying the finisher 1 is secured.

### SECOND EMBODIMENT

The first embodiment is the example of the best mode. However, in the sheet finishing apparatus according to the first embodiment, the two castors 28 may include springs. Each of the two castors 28, the spring-loaded castor 29 and the other spring-loaded castors 30 may be flexible.

For the finisher 1 to be carried stably on the floor surface, finisher 1 needs to use a fixed-direction castor.

The fixed-direction castor refers to a castor in which the direction of movement of the wheel is fixed in one direction. In the fixed-direction castor, the pivotal turn of the wheel is limited or the wheel is unable to pivotally turn.

For example, it is now assumed that the fixed-direction castors are used as the two spring-loaded castors 30 on the side of the MFP 2 and rotary castors are used as the two castors 28 and the one spring-loaded castor 29.

The rotary castor is a castor in which the direction of movement of the wheel can freely be taken in all directions. In the rotary castor, the wheel can freely pivotally turn.

By the way, the fixed-direction castor has a complex structure since the fixed-direction castor requires a structure to regulate the direction of movement. Therefore, the number of components increases. In manufacturing the fixed-direction castor, manufacturing processes increase.

To use the fixed-direction castors as the two spring-loaded castors 30, a component for fixing the direction needs to be separately added to the spring-loaded castors 30. Therefore, the price of the apparatus rises.

The sheet finishing apparatus according to the second embodiment is a finisher using the spring-loaded castors 30 having a fixed-direction structure. The moving mechanism of the sheet finishing apparatus according to the second embodiment is a trolley unit at the bottom of the finisher.

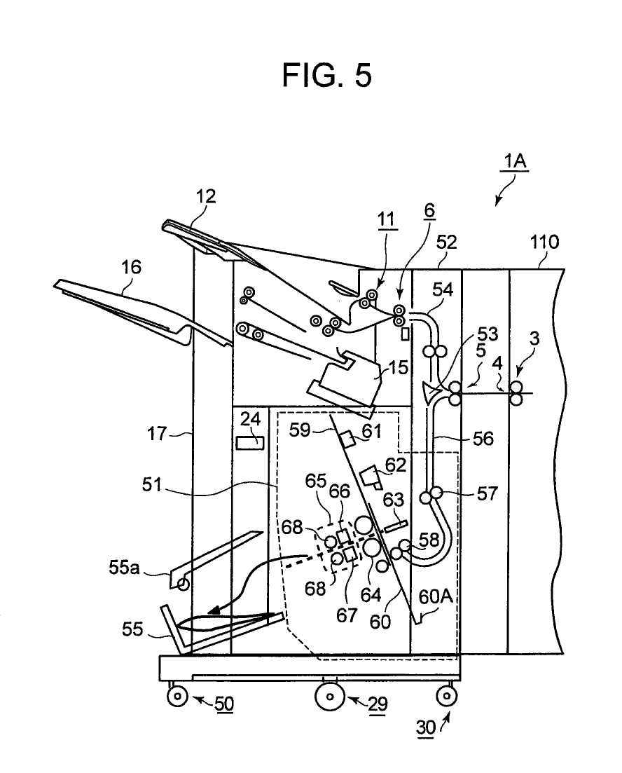

FIG. 5 shows the configuration of the sheet finishing apparatus according to the second embodiment. The reference numerals that are already mentioned refer to the same elements.

A finisher 1A carries sheets to one of the side of the stapler 15 and the side of a saddle unit 51. The saddle unit 51 stitches sheets at its center and folds a sheet bundle along its center.

The finisher 1A has a sheet branching unit 52 which allocates sheets to one of the side of the saddle unit 51 or the side of the fixed tray 12.

The sheet branching unit 52 has a branching member 53, an upper sheet carrying path 54 continuing to the fixed tray 12, and a lower sheet carrying path 56 continuing to a saddle tray 55.

The sheet branching unit 52 supplies sheets to the entrance rollers 6. The controller 24 controls the operation of the saddle unit 51 and the sheet branching unit 52.

The saddle unit 51 drives staples at two positions near the center of one side of the sheet bundle and folds the sheet bundle along its center. The saddle unit 51 outputs the sheet bundle thus bound, to the saddle tray 55.

The saddle unit 51 delivers one sheet to a pair of intermediate rollers 57. The intermediate rollers 57 deliver the sheet to a pair of exit rollers 58. The exit rollers 58 send the sheet to a tray 59. A surface of the tray 59 is sloped. A forward end of the sheet moves toward the top of the slope of the tray 59.

The saddle unit 51 has a stacker 60 below the tray 59. The stacker 60 reciprocates in the sheet carrying direction. The stacker 60 has a stopper 60A. The stopper 60A receives the sheet falling from the top of the slope of the tray 59.

The stacker 60 sequentially stacks the sheets thereon from the side of the tray 59. The stacker 60 forms a sheet bundle and aligns a lower end of the sheet bundle.

The saddle unit 51 has a pair of tray plates 61 in a direction of the depth of the machine body 17. The tray plates 61 align the sheet bundle in a direction orthogonal to the sheet carrying direction. The saddle unit 51 has a stapler 62 substantially at a middle part of the tray 59.

The controller 24 causes the tray 59 to adjust a position of the stacker 60 before stapling the sheet bundle.

The stapler 62 staples the sheet bundle at its center. The controller 24 lowers the stacker 60 until a position where the staple is driven arrives in front of a blade 63.

A position where a fold is to be formed arrives in front of the blade 63. A distal end of the blade 63 pushes a sheet surface that should be an inner surface after the sheet bundle is folded. The blade 63 applies a force to the sheet bundle from right to left.

The finisher 1A has a pair of folding rollers 64 at an end of the traveling direction of the blade 63.

A nip between the folding rollers 64 nips the sheet bundle pushed in by the blade 63 and thus forms a fold on the sheet bundle.

The folding rollers 64 carry the sheet bundle to a discharge mechanism 65 downstream in the sheet carrying direction. The discharge mechanism 65 temporarily stops the carrying of the sheet bundle by the folding rollers 64.

The discharge mechanism 65 has an upper fold reinforcing roller 66, a lower fold reinforcing roller 67, and a pair of carrying rollers 68.

The upper fold reinforcing roller 66 and the lower fold reinforcing roller 67 move while pressing the fold in the direction orthogonal to the sheet carrying direction. The upper folding reinforcing roller 66 and the lower fold reinforcing roller 67 move along a fold line. The fold is thus reinforced.

The upper fold reinforcing roller 66 and the lower fold reinforcing roller 67 output the sheet bundle to the saddle tray 55 via the carrying rollers 68. The sheet bundle is placed on the saddle tray 55.

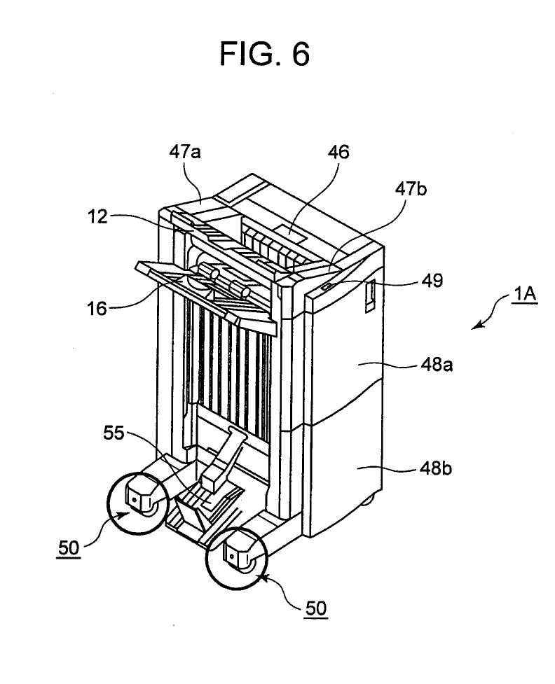

FIG. 6 is a perspective view of the finisher 1A. The reference numerals that are already mentioned refer to the same elements.

The finisher 1A having the finishing mechanism has rear covers 47a and 47b on the top, and an upper cover 48a and a lower cover 48b on the front side. These covers, the poles 25, the base plate 26 as the like shown in FIG. 2 form a part of the machine body 17.

The machine body 17 supports the weight of the mechanism in the upper half of the finisher 1A and the weight of the mechanism in the lower half.

The fixed tray 12 and the paper discharge tray 16 stretch out of the machine body 17. The paper discharge tray 16 moves up and down in response to an input to a staple button on a control panel 49.

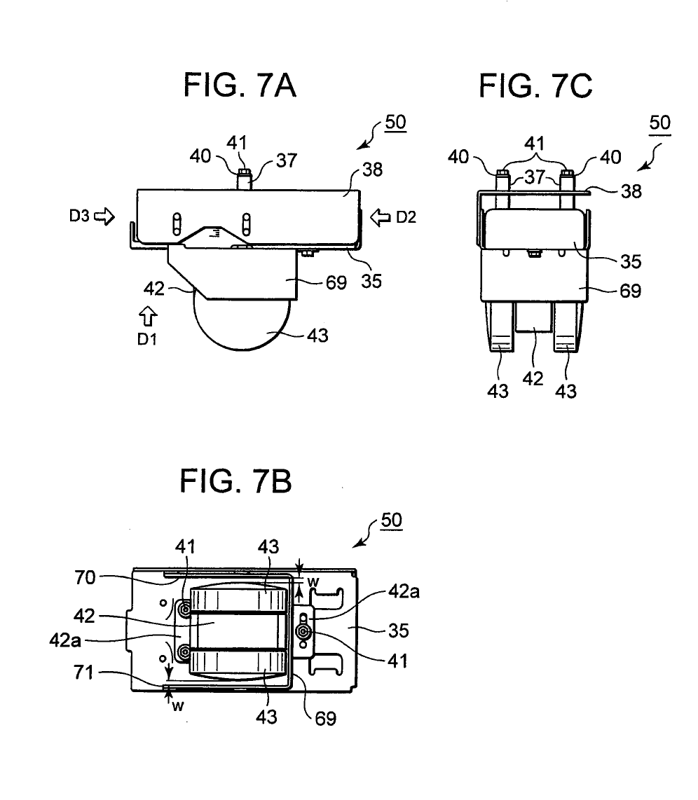

The finisher 1A has two spring-loaded castors 50 at the bottom of the machine body 17. FIG. 7A to FIG. 7C show enlarged views of an example of the spring-loaded castors 50.

FIG. 7A is a side view of the spring-loaded castor 50. FIG. 7B is a bottom view of the spring-loaded castor 50, showing an example as viewed from an arrow D1 in FIG. 7A. FIG. 7C is a front view of the spring-loaded castor 50, showing an example as viewed from an arrow D2 in FIG. 7A. The reference numerals that are already mentioned refer to the same elements.

The spring-loaded castor 50 has the lower bracket 35 which contracts four springs together with the upper bracket 38, the holder 42 (a second holder) fixed to the lower bracket 35, and the double wheels 43 (second wheels) held in the holder 42 as a bearing.

The holder 42 has a top surface 42a. The surface 42a is fixed to a bottom surface of the lower bracket 35 by being fastened with the screws 41 or washers.

The spring-loaded castor 50 has a rotation regulating member 69 at the bottom of the lower bracket 35. The rotation regulating member 69 is obtained by bending a steel plate in U-shape. The rotation regulating member 69 has 3 plate pieces. An upper side of the steel plate bent 90 degrees by pressing is fixed to the lower bracket 35.

As a fixing method, for example, a protrusion formed on the upper side of the steel plate is engaged with a slit formed in the lower bracket 35.

The rotation regulating member 69 has plate surfaces 70 and 71 on its inner side. The plate surfaces 70 and 71 surround the upper half of the wheels 43.

The spring-loaded castor 50 has a gap between the plate surface 70 and a lateral side of one wheel 43. The spring-loaded castor 50 has a gap also between the plate surface 71 and a lateral side of the other wheel 43.

A width w of the gap is of a value within a range that allows free rotation of the wheels 43 and realizes regulation of excessive pivotal turn of the wheels 43.

The width w is determined on the basis of the diameter of the wheels 43, the size of the spring-loaded castor 50 or the like. The width w is, for example, about 1 millimeter.

The finisher 1A of such configuration is pushed on the floor surface toward the MFP 2 from a place away from the MFP 2. Then, the two spring-loaded castors 50, the two castors 28 on the side of the MFP 2, and the spring-loaded castor 29 situated at the apparatus center of the finisher rotate.

FIG. BA is a back view of one spring-loaded castor 50, showing an example as viewed from an arrow D3 in FIG. 7A. An axis 72 is an axis for pivotal turn on the floor surface.

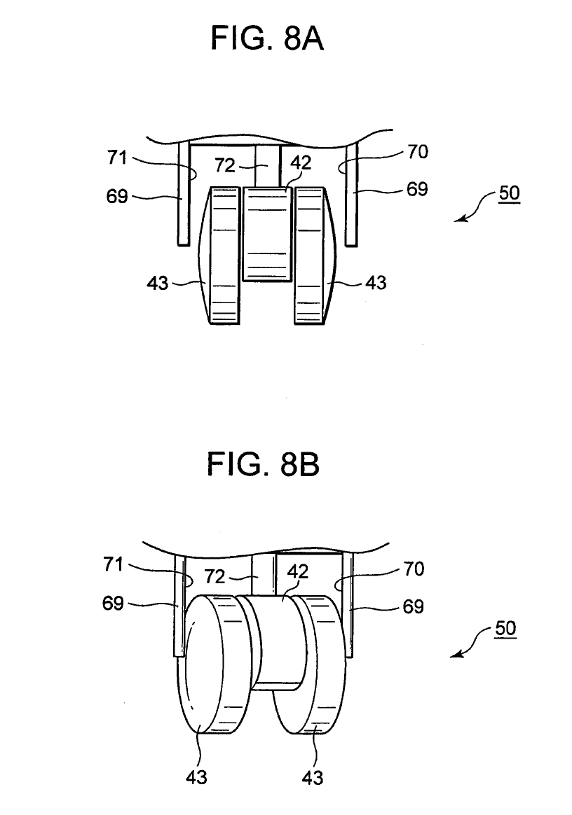

When the floor surface is flat, the two wheels 43 rotate as in the example shown in FIG. 8A. The finisher 1A moves toward the MFP 2.

With the spring-loaded castor 29, the finisher 1A smoothly moves on the floor surface. Moving the finisher 1A from the MFP 2 and moving the finisher 1A toward the MPF 2 are repeated. A position on the floor surface is thus adjusted.

The spring-loaded castor 29 sinks and flexes because of the weight of the finisher 1A. The height of the supply port 5 from the floor surface and the height of the discharge port 4 from the floor surface are adjusted.

FIG. 8B shows the state where the rotation regulating member 69 regulates the rotation of the spring-loaded castor 50. The same reference numerals in FIG. 8A and FIG. 8B denote the same elements.

When a direction of a force applied to the finisher 1A is not appropriate or when the floor surface is sloped or stepped, a Toe angle of the wheels 43 changes.

The Toe angle refers to a rotational displacement about a perpendicular line (z-axis) as a center of rotation.

The two wheels 43 contact the plate surfaces 70 and 71 on the inner side of the rotation regulating member 69.

The axis 72 pivotally turns. The Toe angle of the two wheels 43 that are rotating becomes increasingly greater in the direction of forward movement or in the direction of backward movement. The rotation regulating member 69 regulates the increase in the Toe angle of each wheel 43. On the rotation regulating member 69, a frictional force is generated because of the contact. The wheels 43 thus stop rotating.

Since there are the gaps between the rotation regulating member 69 and the wheels 43, the finisher 1A can allow the spring-loaded castors 50 to rotate when necessary and prevent the spring-loaded castors 50 from rotating when not necessary.

A sheet finishing apparatus according to a related art has one or more castors which freely pivotally turn. In this castor, the Toe angle of the wheels increases in the direction of forward movement or the direction of backward movement of the castor.

When the floor surface is sloped, or when the direction of the force applied to the sheet finishing apparatus is not appropriate, the castor travels in an unintended direction. As the sheet finishing apparatus moves by a certain distance, excessive movement of the machine body occurs.

Moreover, in the sheet finishing apparatus according to the related art, two castors of the plural castors are of a fixed-direction type and two castors are of a rotary system.

However, the fixed-direction castor needs a structure to maintain the direction of movement of the wheels.

Generally, the fixed-direction castor is different from the rotary castor as follows:

(1) the price is high;

(2) a large installation area is required in relation to an area of the floor surface occupied by the machine body; and

(3) workability (work efficiency) in assembling the castor is low.

Meanwhile, in the finisher 1A, the spring-loaded castor 50 is inexpensive since only one axis 72 is employed. An area required for installing the spring-loaded castor 50 is small in relation to an area occupied by the machine body 17. Since the rotation regulating member 69 is used, the work efficiency in assembling the spring-loaded castor 50 is better.

Thus, with the finisher 1A, all the three problems of the sheet finishing apparatus according to the related art can be solved.

In the second embodiment, the rotation regulating member 69 is desirable to be installed at two positions on the side close to the MFP 2. However, in the finisher 1A, the rotation regulating member 69 may also be attached at all the four corners of the base plate 26.

In this manner, the spring-loaded castor 50 has a spacing of approximately 1 mm between each wheel 43 and the rotation regulating member 69. Both the easiness of rotation and easiness of straight movement of the spring-loaded castor 50 can be realized.

If the gap is too wide, the operability of the finisher 1A is impaired when the spring-loaded castor 50 moves straight.

If the gap is too narrow, the spring-loaded castor 50 and the rotation regulating member 69 contact each other, thus accelerating friction.

### Other Examples

In the above embodiments, the base plate 26 may be flat without the opening 44. Through holes to let the distal ends of the bosses 37 out may be provided in the bottom surface of the base plate 26.

In the above embodiments, the elastic member is a coil spring. However, as the elastic member, a cantilever spring, or a plate-like spring such as a leaf spring may also be used. The elastic member may also be a helical spring. The elastic member may also be an elastic rubber member. An actuator may also be used as the elastic member.

In the above embodiments, the movement of the upper bracket 38 is regulated by the bosses 37, the washers 40 and the screws 41. To regulate the upper bracket 38, flanged screws may be used instead of the washers 40. Alternatively, spacers may be inserted between the screws 41, the washers 40 and the bosses 37.

The stapler 15 is described as an example of the sheet finishing mechanism. However, the sheet finishing apparatus according to the embodiments may be equipped with various finishing mechanisms.

The structure of the spring-loaded castor 29 can be changed in various ways. The technique of generating elasticity can be changed in various manners, too. The superiority of the sheet finishing apparatus according to the embodiments over inventions carried out simply by changing the structure and the elastic member should not be impaired.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. A sheet finishing apparatus comprising:
a machine body including a supply port for a sheet from an image forming apparatus and a discharge port for a sheet bundle including one or more of the sheet;
a finishing mechanism configured to perform finishing of the sheet supplied from the supply port and generate the sheet bundle;
a frame structure configured to support the finishing mechanism and the machine body;
a base provided on the frame structure;
plural first holders respectively pivotally supported on the base and each of the plural first holders is directed downward from the base and pivotally turns around a vertical pivot;
plural first wheels respectively pivotally supported on the plural first holders and each of the plural first wheels rotates around a horizontal axle shifted from the pivot of each first holder;
a second holder pivotally supported on the base and is directed downward from a part of the base, the part passing through an apparatus center of the sheet finishing apparatus, and pivotally turns around a vertical pivot;
a second wheel pivotally supported on the second holder, rotates around a horizontal axle intersecting the pivot of the second holder, and has a greater diameter than a diameter of the first wheel; and
an elastic member connected between the second holder and the base, and extends and reduces a spacing between the horizontal axle of the second wheel and the base.

2. The apparatus of claim 1, wherein the second holder passes near a center of gravity of the sheet finishing apparatus.

3. The apparatus of claim 1, wherein a moment of inertia around the apparatus center at a position of the second holder is relatively smaller than a moment of inertia around a perpendicular line at a different position from the position.

4. The apparatus of claim 1, wherein the elastic member is a coil spring.

5. The apparatus of claim 1, wherein the base is substantially a rectangular plate, and of the first wheels of the four first holders provided at four corners of the plate, a pair of the first wheels are arranged at one pair of opposite angles and the other pair of the first wheels are arranged at the other pair of opposite angles.

6. The apparatus of claim 1, further comprising a rotation regulating member provided on the second holder and regulates the pivotal turn of the second wheel about the vertical pivot.

7. The apparatus of claim 6, wherein the rotation regulating member has plural plate pieces, the rotation regulating member being obtained by bending a steel plate in U-shape, and a pair of the plate pieces surrounding the second wheel with a gap between the plate pieces and the second wheel.

8. The apparatus of claim 7, wherein the pair of plate pieces have the gap having a width corresponding to free rotation of the second wheel around the horizontal axle and a preset value of a Toe angle of the second wheel.

9. The apparatus of claim 7, wherein the pair of plate pieces have the gap having a width corresponding to the diameter of the second wheel.

10. The apparatus of claim 7, wherein the pair of plate pieces have the gap of approximately 1 millimeter between the plate pieces and the second wheel.

11. A moving mechanism of a sheet finishing apparatus comprising:
a frame structure configured to support a machine body including a sheet finishing mechanism;
a base provided on the frame structure;
plural first holders respectively pivotally supported on the base and each of the plural first holders is directed downward from the base and pivotally turns around a vertical pivot;
plural first wheels respectively pivotally supported on the plural first holders and each of the plural first wheels rotates around a horizontal axle shifted from the pivot of each first holder;
a second holder pivotally supported on the base and is directed downward from a part of the base, the part passing through an apparatus center of the sheet finishing apparatus, and pivotally turns around a vertical pivot;
a second wheel pivotally supported on the second holder, rotates around a horizontal axle intersecting the pivot of the second holder, and has a greater diameter than a diameter of the first wheel; and
an elastic member connected between the second holder and the base, and extends and reduces a spacing between the horizontal axle of the second wheel and the base.

12. The moving mechanism of claim 11, wherein the second holder passes near a center of gravity of the sheet finishing apparatus.

13. The moving mechanism of claim 11, wherein a moment of inertia around the apparatus center at a position of the second holder is relatively smaller than a moment of inertia around a perpendicular line at a different position from the position.

14. The moving mechanism of claim 11, wherein the elastic member is a coil spring.

15. The moving mechanism of claim 11, wherein the base is substantially a rectangular plate, and of the first wheels of the four first holders provided at four corners of the plate, a pair of the first wheels are arranged at one pair of opposite angles and the other pair of the first wheels are arranged at the other pair of opposite angles.

16. The moving mechanism of claim 11, further comprising a rotation regulating member provided on the second holder and regulates the pivotal turn of the second wheel about the vertical pivot.

17. The moving mechanism of claim 16, wherein the rotation regulating member has plural plate pieces, the rotation regulating member being obtained by bending a steel plate in U-shape, and a pair of the plate pieces surrounding the second wheel with a gap between the plate pieces and the second wheel.

18. A moving method for a sheet finishing apparatus comprising:
directing downward plural first holders which respectively pivotally support first wheels, each of the first wheels rotating around a horizontal axle and pivotally turning around a vertical pivot shifted from the horizontal axle, from a base of a frame structure supporting the sheet finishing apparatus, and pivotally supporting the first holders on the base;
directing downward a second holder which pivotally supports a second wheel, the second wheel rotating around a horizontal axle and having a greater diameter than a diameter of the first wheel and
pivotally turning around a vertical pivot intersecting the horizontal axle, from a part of the base, the part passing through an apparatus center of the sheet finishing apparatus, and pivotally supporting the second holder on the base;
the second holder supporting the apparatus center of the sheet finishing apparatus as an elastic member connected between the second holder and the base is loaded with a weight of the sheet finishing apparatus; and
the sheet finishing apparatus moving on a floor surface by a combination of the plural first wheels and the second wheel.

19. The method of claim 18, wherein in rotation of the second wheel on the floor surface, a rotation regulating member regulates the pivotal turn of the second wheel around the vertical pivot.

20. The method of claim 19, wherein in regulating the pivotal turn by the rotation regulating member, a pair of place pieces, of plural plate pieces each being obtained by bending a steel plate in U-shape, contacts the second wheel and applies a frictional force to the second wheel.
